(19) United States
(12) Patent Application Publication
(10) Pub. No.: US 2025/0357613 A1
(43) Pub. Date: Nov. 20, 2025

(54) WIRE HARNESS

(71) Applicant: YAZAKI CORPORATION, Tokyo (JP)

(72) Inventors: Tatsuya Oga, Makinohara-shi (JP); Katsunori Sato, Makinohara-shi (JP); Mariko Nakagawa, Makinohara-shi (JP); Seigo Mochizuki, Fujieda-shi (JP)

(21) Appl. No.: 19/183,709

(22) Filed: Apr. 18, 2025

(30) Foreign Application Priority Data
May 15, 2024 (JP) 2024-079220

(51) Int. Cl. H01M 50/298; H01M 50/204; H01M 50/507; H01M 50/519

(52) U.S. Cl. CPC H01M 50/298; H01M 50/507; H01M 50/519; H01M 50/204

(57) ABSTRACT

Provided is a wire harness including a flat wiring member and a case having a passage with a groove shape for accommodating the flat wiring member, where the passage has a support wall facing one main surface of the flat wiring member and a protrusion protruding from the support wall, and the flat wiring member has a through hole, and is accommodated in the passage in a state where the flat wiring member is positioned by the protrusion inserted into the through hole.

### CROSS-REFERENCE TO RELATED APPLICATION(S)

The present application claims priority to and incorporates by reference the entire contents of Japanese Patent Application No. 2024-079220 filed in Japan on May 15, 2024.

### BACKGROUND OF THE INVENTION

### 1. Field of the Invention

The present invention relates to a wire harness.

### 2. Description of the Related Art

In recent years, there is a wire harness having a flat wiring member. JP 2022-173 609 A discloses a bus bar module including a plurality of bus bars, a circuit body having a plate shape with flexibility, and a case that accommodates the circuit body and the bus bars.

When a flat wiring member is accommodated in a case, it is desirable to be able to suppress positional deviation of the flat wiring member inside the case.

### SUMMARY OF THE INVENTION

An object of the present invention is to provide a wire harness that can suppress positional deviation of a flat wiring member inside a case.

In order to achieve the above mentioned object, a wire harness according to one aspect of the present invention includes a flat wiring member; and a case having a passage with a groove shape for accommodating the flat wiring member, wherein the passage has a support wall facing one main surface of the flat wiring member and a protrusion protruding from the support wall, and the flat wiring member has a through hole, and is accommodated in the passage in a state where the flat wiring member is positioned by the protrusion inserted into the through hole.

The above and other objects, features, advantages and technical and industrial significance of this invention will be better understood by reading the following detailed description of presently preferred embodiments of the invention, when considered in connection with the accompanying drawings.

### BRIEF DESCRIPTION OF THE DRAWINGS

FIG. 1 is a diagram illustrating a wire harness and a battery module according to an embodiment;

FIG. 2 is an exploded perspective view of the wire harness according to the embodiment;

FIG. 3 is a plan view of a flat wiring member according to the embodiment;

FIG. 4 is a plan view of a case according to the embodiment;

FIG. 5 is a plan view of the wire harness according to the embodiment; and

FIG. 6 is a cross-sectional view of the wire harness according to the embodiment.

### DETAILED DESCRIPTION OF THE PREFERRED EMBODIMENTS

A wire harness according to an embodiment of the present invention will be described below in detail with reference to the drawings. However, the present invention is not limited to the present embodiment. Furthermore, components in the following embodiment include those that a person skilled in the art could easily imagine or that are substantially identical.

### Embodiment

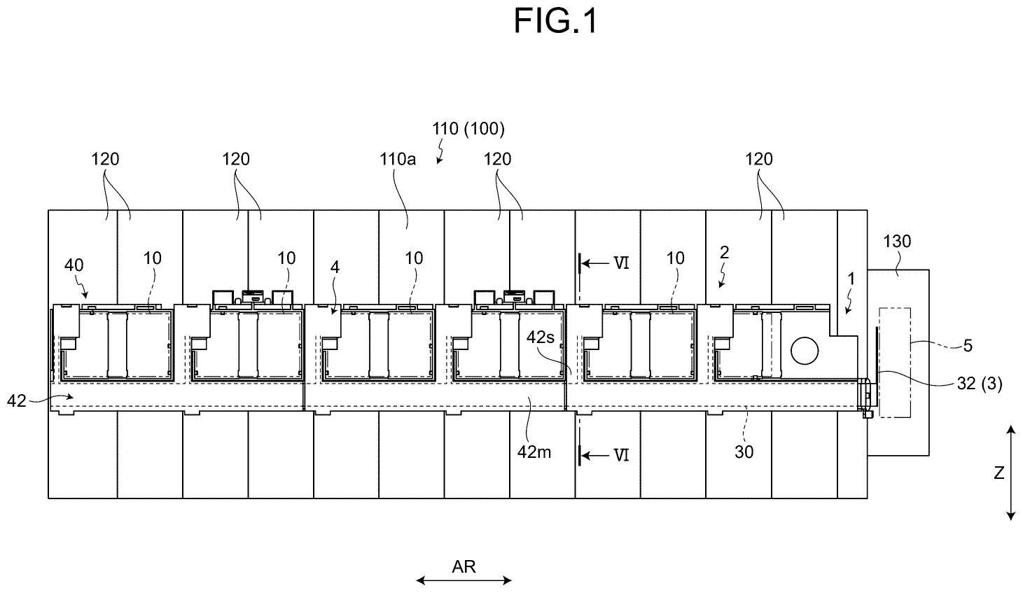

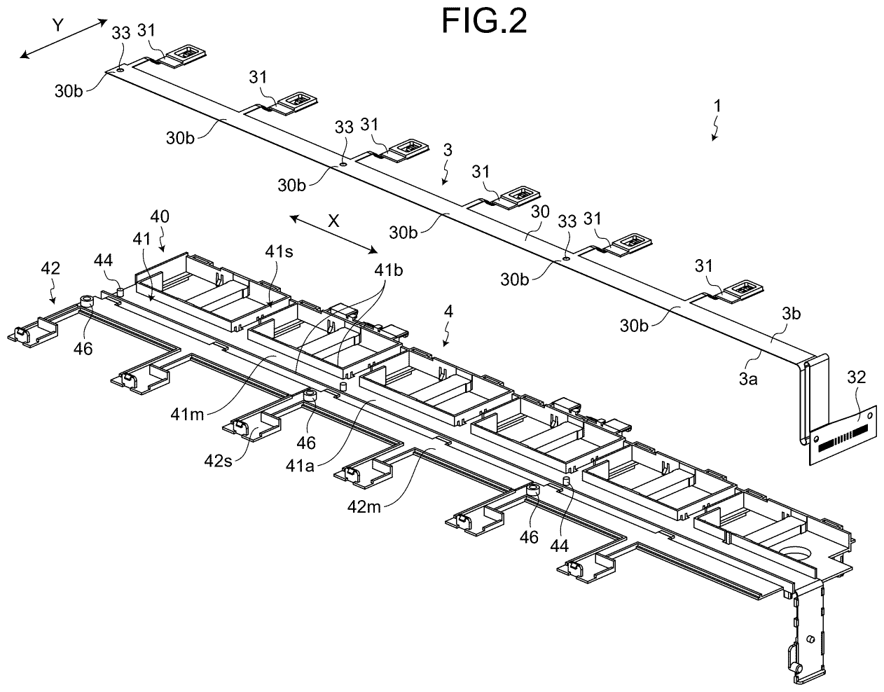

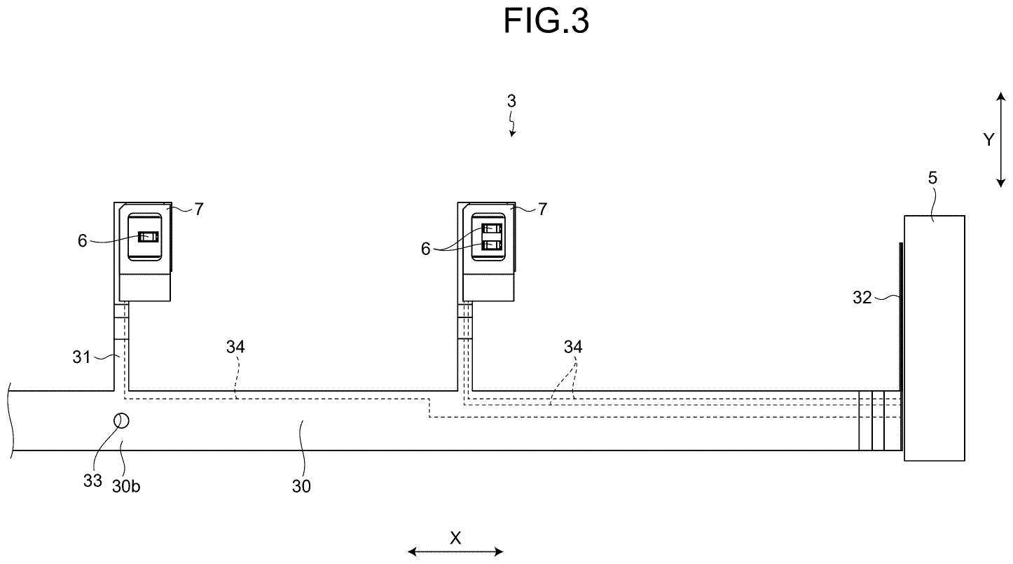

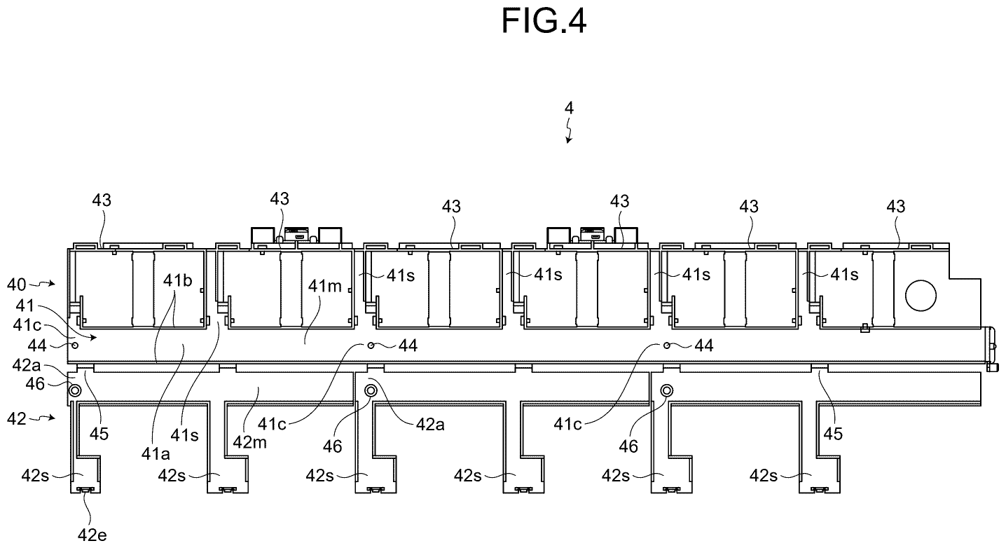

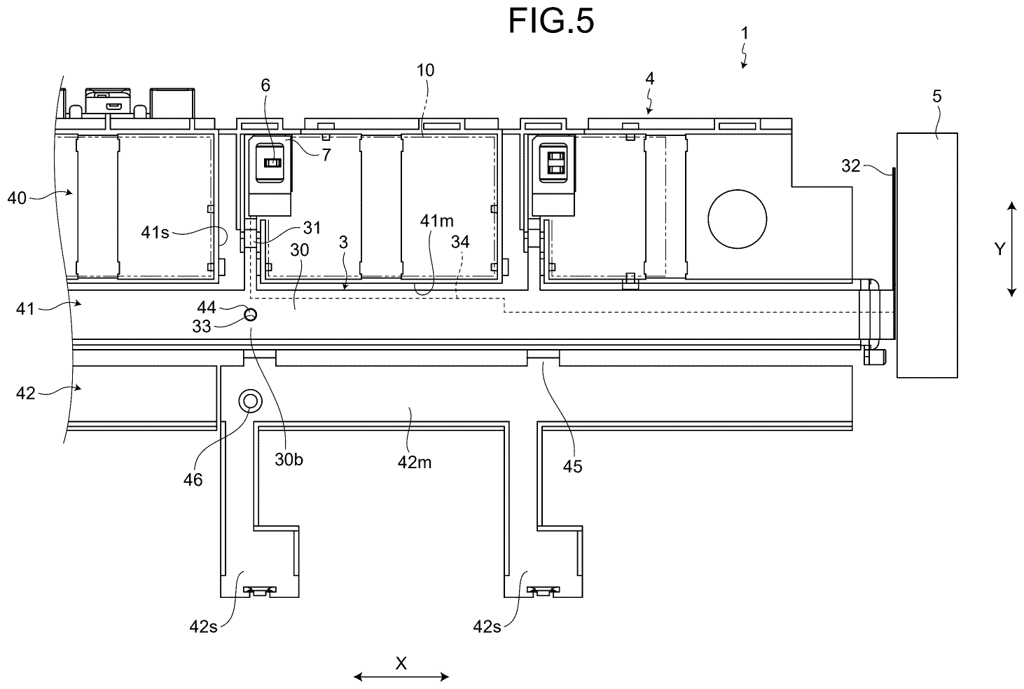

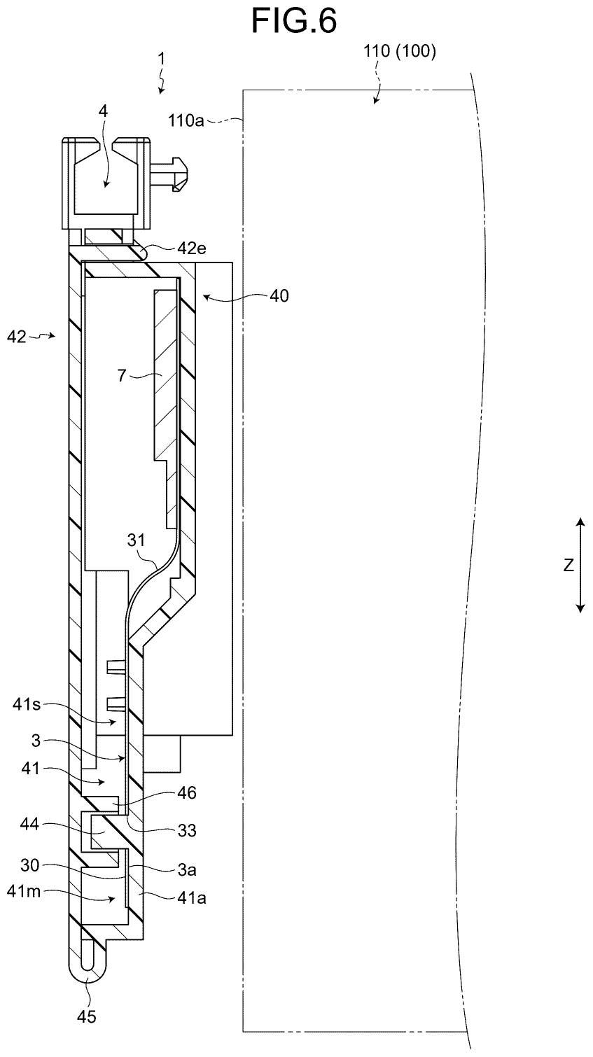

The embodiment will be described with reference to FIGS. 1 to 6. The present embodiment relates to a wire harness. FIG. 1 is a diagram illustrating a wire harness and a battery module of the embodiment, FIG. 2 is an exploded perspective view of the wire harness of the embodiment, FIG. 3 is a plan view of a flat wiring member of the embodiment, FIG. 4 is a plan view of a case of the embodiment, FIG. 5 is a plan view of the wire harness of the embodiment, and FIG. 6 is a cross-sectional view of the wire harness of the embodiment. FIG. 6 illustrates a cross section taken along the line VI-VI of FIG. 1.

A wire harness 1 of the present embodiment is arranged in, for example, a battery module 110 of a battery pack 100 as illustrated in FIG. 1. The battery pack 100 is mounted as a power source in a vehicle such as an electric vehicle or a hybrid electric vehicle. As illustrated in FIG. 1, the battery module 110 has a plurality of battery cells 120 arranged side by side. In this specification, a direction in which the plurality of battery cells 120 are arranged is referred to as an arrangement direction AR. A monitoring device 130 is disposed at an end of the battery module 110 in the arrangement direction AR.

The wire harness 1 of the present embodiment has a flat wiring member 3 and a case 4. The wire harness 1 is connected to a plurality of bus bars 10 to form a bus bar module 2. The bus bar 10 is a conductor formed from a conductive metal plate, and is fixed to an electrode of the battery cell 120. The bus bar 10 connects, for example, two adjacent battery cells 120 in series. The wire harness 1 connects the plurality of bus bars 10 to the monitoring device 130 of the battery pack 100. The wire harness 1 may connect a thermistor disposed in the battery cell 120 to the monitoring device 130. The monitoring device 130 is a device that monitors a state of the battery cell 120, such as voltage and temperature.

The flat wiring member 3 illustrated in FIG. 2 and the like is a flexible, flat wiring member. The flat wiring member 3 is configured so that it can be wired in a bent state. The illustrated flat wiring member 3 is a flexible printed circuit board (FPC). The flat wiring member 3, which is a flexible printed circuit board, has a base film, a coverlay, and a conductive layer. The base film and the coverlay are flexible insulating resin layers. The conductive layer is protected by being interposed between the base film and the coverlay. The conductive layer is, for example, a conductive metal foil, and has a plurality of circuit patterns 34.

As illustrated in FIG. 2, the flat wiring member 3 has two main surfaces 3a and 3b. The flat wiring member 3 is accommodated in the case 4 so that one main surface 3a faces a support wall 41a of the case 4. The flat wiring member 3 has a trunk portion 30 and a plurality of branch portions 31. The trunk portion 30 is a main body portion having a plurality of circuit patterns. The shape of the trunk portion 30 in a plan view is substantially rectangular. In this specification, a longitudinal direction of the trunk portion 30 is referred to as a “longitudinal direction X”, and a width direction of the trunk portion 30 is referred to as a “width direction Y”. The width direction Y is perpendicular to the longitudinal direction X.

At an end of the trunk portion 30 in the longitudinal direction X, a connection portion 32 to be connected to a connector 5 is provided. The plurality of circuit patterns 34 are connected to terminals of the connector 5 at the connection portion 32. The connector 5 is fitted to the monitoring device 130 and connects the plurality of circuit patterns 34 to the monitoring device 130.

The flat wiring member 3 has a through hole 33 formed therein. The through hole 33 penetrates the flat wiring member 3 along the thickness direction of the flat wiring member 3. As described below, in the wire harness 1 of the present embodiment, protrusions 44 provided on the case 4 prevent the flat wiring member 3 from being displaced.

As illustrated in FIG. 2, the trunk portion 30 of the flat wiring member 3 has a branch point 30b where the branch portion 31 branches off. The branch portion 31 extends in the width direction Y from the branch point 30b of the trunk portion 30. The illustrated trunk portion 30 has a plurality of branch points 30b corresponding to a plurality of branch portions 31. The flat wiring member 3 has the through hole 33 arranged at the branch point 30b.

As illustrated in FIG. 3, the through hole 33 is disposed at a center in the width direction Y of the branch point 30b of the trunk portion 30. In the present embodiment, the through hole 33 has a circular shape. The plurality of through holes 33 are arranged in the longitudinal direction X at equal intervals.

The branch portions 31 extend in the width direction Y from the trunk portion 30. In other words, the branch portion 31 extends laterally from the trunk portion 30. The circuit pattern 34 extends from the branch portion 31 through the trunk portion 30 to the connection portion 32, and is connected to the connector 5 at the connection portion 32. A chip fuse 6 is mounted on a tip of the branch portion 31. A reinforcing plate 7 surrounding the chip fuse 6 is disposed at a tip of the branch portion 31. The reinforcing plate 7 is formed of, for example, a conductive metal plate. The circuit pattern 34 is connected to the reinforcing plate 7 via the chip fuse 6. The bus bar 10 is electrically connected to the reinforcing plate 7. The reinforcing plate 7 may be a part of the bus bar 10.

As illustrated in FIG. 4, the case 4 has a main body 40 having a passage 41 and a cover 42 that covers the passage 41. The case 4 is molded from, for example, an insulating synthetic resin. In the case 4 of the present embodiment, the main body 40 and the cover 42 are integrally molded. However, the main body 40 and the cover 42 may be separate members.

The main body 40 of the present embodiment has a substantially rectangular shape in a plan view. The main body 40 has the passage 41 and a plurality of holding portions 43. The passage 41 is a groove-shaped passage that accommodates the flat wiring member 3. The passage 41 has a main passage 41m and a plurality of branch passages 41s. The main passage 41m accommodates the trunk portion 30 of the flat wiring member 3. The main passage 41m extends in the longitudinal direction of the main body 40 from one end to the other end of the main body 40. The branch passage 41s branches off from the main passage 41m and accommodates the branch portion 31 of the flat wiring member 3.

The passage 41 has the support wall 41a and a pair of side walls 41b. The support wall 41a faces one main surface 3a of the flat wiring member 3 and is a wall portion that supports the flat wiring member 3. The pair of side walls 41b are erected from the support wall 41a and face each other with the support wall 41a therebetween. The support wall 41a and the pair of side walls 41b form an accommodation space having a rectangular cross-sectional shape.

The holding portion 43 is a portion that accommodates and holds the bus bar 10. The plurality of holding portions 43 are disposed adjacent to the main passage 41m and are lined up along the main passage 41m. The holding portion 43 is formed in a frame shape and has a locking portion that locks the bus bar 10. The branch passage 41s extends between two adjacent holding portions 43.

The main body 40 has a plurality of protrusions 44 protruding from the support wall 41a. The protrusion 44 is disposed at the branch point 41c where the branch passage 41s branches off from the main passage 41m. The protrusion 44 in the present embodiment has a columnar or cylindrical shape. That is, a cross-sectional shape of the protrusion 44 in the present embodiment is circular.

The cover 42 is connected to the main body 40 via a hinge portion 45 having flexibility. The cover 42 has a main cover 42m that covers the main passage 41m, and a plurality of branch covers 42s that cover the branch passages 41s. The main cover 42m is disposed on an opposite side to the holding portion 43 side with respect to the main passage 41m. The main cover 42m has a substantially rectangular shape in a plan view. The branch cover 42s extends from the main cover 42m in the width direction of the main cover 42m. The branch cover 42s is formed so as to be able to cover the branch portion 31 and the reinforcing plate 7. An engagement portion 42e that engages with the main body 40 is provided at a tip of the branch cover 42s.

The cover 42 has a plurality of restriction portions 46 that correspond to the protrusions 44. The restriction portion 46 is disposed at the branch point 42a at which the branch cover 42s branches off from the main cover 42m. The restriction portion 46 is configured to restrict the protrusion 44 from coming out of the through hole 33 of the flat wiring member 3. More specifically, the restriction portion 46 is configured to support the flat wiring member 3 adjacent to the protrusion 44 when the cover 42 is in a closed state covering the passage 41.

The restriction portion 46 in the present embodiment has a cylindrical shape into which the protrusion 44 can be inserted. The restriction portion 46 has, for example, a cylindrical shape. The restriction portion 46 is disposed so as to be able to engage with the protrusion 44 when the cover 42 is closed.

FIG. 5 illustrates the flat wiring member 3 arranged in the case 4. The flat wiring member 3 is accommodated in the passage 41 with the trunk portion 30 extending into the main passage 41m and the branch portion 31 extending into the branch passage 41s. The protrusion 44 of the case 4 is inserted into the through hole 33 of the flat wiring member 3 to position the flat wiring member 3. The protrusions 44 position the flat wiring member 3 in both the longitudinal direction X and the width direction Y. The protrusion 44 penetrates the branch point 30b of the flat wiring member 3 to position the branch point 30b. Therefore, the protrusion 44 can regulate positional deviation of the branch portion 31 with respect to the branch passage 41s.

From the state illustrated in FIG. 5, the cover 42 of the case 4 is closed. The cover 42 rotates while deforming the hinge portion 45 and engages with the main body 40. The wire harness 1 with the cover 42 closed is assembled to the battery module 110 as illustrated in FIG. 1. FIG. 6 illustrates a cross section taken along the line VI-VI of FIG. 1.

The wire harness 1 of the present embodiment is disposed on a side surface 110a of the battery module 110. The side surface 110a is a side surface that extends in an up-down direction Z of the battery module 110. Electrodes of the battery cell 120 are disposed on the side surface 110a. The support wall 41a of the case 4 faces the side surface 110a of the battery module 110. The trunk portion 30 of the flat wiring member 3 is wired with one main surface 3a facing the side surface 110a of the battery module 110. As illustrated in FIG. 1, the trunk portion 30 extends inside the case 4 in the arrangement direction AR.

As illustrated in FIG. 6, the protrusion 44 of the case 4 is inserted into the through hole 33 of the flat wiring member 3. The protrusion 44 supports the flat wiring member 3 in the up-down direction Z and positions the flat wiring member 3. In the present embodiment, the trunk portion 30 is located below the branch portions 31. In this case, gravity acting on the trunk portion 30 applies a load to the branch portion 31. Furthermore, when the trunk portion 30 moves up and down due to vibrations caused when the vehicle is traveling, the branch portions 31 are likely to be subjected to loads. In the wire harness 1 of the present embodiment, the protrusions 44 support the trunk portion 30 and can reduce the load on the branch portions 31.

The restriction portion 46 is adjacent to the protrusion 44 when the cover 42 is in a closed state in which the cover 42 covers the passage 41. The restriction portion 46 is adjacent to and faces a side surface of the protrusion 44. For example, in the cross section of FIG. 6, the restriction portion 46 faces the side surface of the protrusion 44 in the up-down direction Z. In other words, the restriction portion 46 is configured to overlap the protrusion 44 when the protrusion 44 is viewed from the side.

The protrusion 44 faces the trunk portion 30 in a depth direction of the passage 41. The protrusion 44 supports the flat wiring member 3 and can prevent the protrusion 44 from falling out of the through hole 33. The restriction portion 46 can restrict the flat wiring member 3 from floating up from the support wall 41a. Therefore, the restriction portion 46 can reduce the load applied to the branch portion 31.

As described above, the wire harness 1 of the present embodiment includes the flat wiring member 3 and the case 4. The case 4 has the passage 41 having a groove shape that accommodates the flat wiring member 3. The passage 41 has the support wall 41a facing one main surface 3a of the flat wiring member 3, and the protrusion 44 protruding from the support wall 41a. The flat wiring member 3 has the through hole 33. The flat wiring member 3 is accommodated in the passage 41 while being positioned by the protrusion 44 inserted into the through hole 33. According to the wire harness 1 of the present embodiment, it is possible to suppress positional deviation of the flat wiring member 3 in the passage 41.

The case 4 of the present embodiment has the main body 40 having the passage 41 and the cover 42 that covers the passage 41. The cover 42 has the restriction portion 46. The restriction portion 46 is formed so as to support the flat wiring member 3 adjacent to the protrusion 44 when the cover 42 is in a closed state covering the passage 41 and to restrict the protrusion 44 from coming out of the through hole 33. The case 4 having the restriction portion 46 can more reliably suppress the positional deviation of the flat wiring member 3.

The restriction portion 46 may be formed so as to interpose the flat wiring member 3 between the restriction portion 46 and the support wall 41a. In this case, the flat wiring member 3 is interposed between the tip of the restriction portion 46 and the support wall 41a. Such a restriction portion 46 can more reliably suppress the positional deviation of the flat wiring member 3.

The restriction portion 46 in the present embodiment has a cylindrical shape. In the closed state in which the cover 42 covers the passage 41, the protrusion 44 is inserted into the restriction portion 46. With this configuration, positional deviation in the relative positions of the protrusion 44 and the restriction portion 46 is suppressed. The restriction portion 46 that fits with the protrusion 44 can more reliably suppress positional deviation of the flat wiring member 3.

The flat wiring member 3 of the present embodiment has the trunk portion 30 having a flat plate shape and a plurality of branch portions 31 extending laterally from the trunk portion 30. The through hole 33 passes through the trunk portion 30. By suppressing the positional deviation of the trunk portion 30, the load on the branch portions 31 is reduced.

The case 4 of the present embodiment is assembled to the battery module 110 having a plurality of battery cells 120. When the case 4 is assembled to the battery module 110, the support wall 41a faces the side surface 110a extending in the up-down direction Z of the battery module 110. The trunk portion 30 has one main surface 3a facing the side surface 110a of the battery module 110, and extends in the arrangement direction of the plurality of battery cells 120. In such a configuration, the positional deviation of the trunk portion 30 is suppressed, and the load on the branch portions 31 is reduced.

The through hole 33 in the present embodiment is disposed at the branch point 30b of the trunk portion 30 where the branch portion 31 branches off. By suppressing the positional deviation of the branch point 30b, the load on the branch portion 31 is effectively reduced.

The number and arrangement of the protrusions 44 in the passage 41 are not limited to the illustrated number and arrangement. For example, the protrusions 44 may be disposed at all branch points 30b. For example, the protrusion 44 may be disposed at a location on the main passage 41m other than the branch point 30b. The number and arrangement of the through holes 33 in the flat wiring member 3 are set according to the number and arrangement of the protrusions 44 in the case 4.

The shape of the restriction portion 46 is not limited to a cylindrical shape. The shape of the restriction portion 46 may be a tubular shape other than a cylindrical shape. The shape of the restriction portion 46 does not have to be cylindrical. The restriction portion 46 may be a plate-shaped or rod-shaped rib.

The flat wiring member 3 is not limited to a flexible printed circuit board. The flat wiring member 3 may be a flexible flat cable (FFC) or other plate-shaped wiring member.

The contents disclosed in the above embodiment can be implemented in appropriate combinations.

In the wire harness of the present embodiment, the passage of the case has the support wall facing one main surface of the flat wiring member and the protrusion protruding from the support wall, and the flat wiring member has the through hole and is accommodated in the passage while being positioned by the protrusion inserted into the through hole. According to the wire harness of the present embodiment, it is possible to suppress positional deviation of the flat wiring member inside the case.

Although the invention has been described with respect to specific embodiments for a complete and clear disclosure, the appended claims are not to be thus limited but are to be construed as embodying all modifications and alternative constructions that may occur to one skilled in the art that fairly fall within the basic teaching herein set forth.

What is claimed is:

1. A wire harness comprising:
a flat wiring member; and
a case having a passage with a groove shape for accommodating the flat wiring member, wherein
the passage has a support wall facing one main surface of the flat wiring member and a protrusion protruding from the support wall, and
the flat wiring member has a through hole, and is accommodated in the passage in a state where the flat wiring member is positioned by the protrusion inserted into the through hole.

2. The wire harness according to claim 1, wherein
the case includes a main body having the passage and a cover covering the passage,
the cover has a restriction portion, and
the restriction portion is formed to support the flat wiring member adjacent to the protrusion when the cover is in a closed state covering the passage, and to restrict the protrusion from coming out of the through hole.

3. The wire harness according to claim 2, wherein
the restriction portion is formed so as to interpose the flat wiring member between the restriction portion and the support wall.

4. The wire harness according to claim 2, wherein
the restriction portion has a cylindrical shape, and
the protrusion is inserted into the restriction portion in the closed state.

5. The wire harness according to claim 1, wherein
the flat wiring member has a trunk portion having a flat plate shape and a plurality of branch portions extending laterally from the trunk portion, and
the through hole penetrates the trunk portion.

6. The wire harness according to claim 5, wherein
the case is assembled to a battery module having a plurality of battery cells,
when the case is assembled to the battery module, the support wall faces a side surface of the battery module that extends in an up-down direction, and
the trunk portion has the one main surface facing the side surface of the battery module and extends in an arrangement direction of the plurality of battery cells.

7. The wire harness according to claim 5, wherein
the through hole is disposed at a branch point of the trunk portion where the branch portion branches off.
